(19) United States
(12) Patent Application Publication
(10) Pub. No.: US 2017/0115092 A1
(43) Pub. Date: Apr. 27, 2017

(54) ARM SLEEVE WITH RETRACTABLE ELBOW SPIKE

(71) Applicant: Michael G. Holmes, SR., Kinsale, VA (US)

(72) Inventor: Michael G. Holmes, SR., Kinsale, VA (US)

(21) Appl. No.: 14/920,973

(22) Filed: Oct. 23, 2015

(51) Int. Cl. F41B 15/06; B26B 27/00

(52) U.S. Cl. CPC F41B 15/06; B26B 27/007

(57) ABSTRACT

A self-defense apparatus is provided. The apparatus includes a sleeve sized to fit over an arm of a user, with a forearm portion, and an elbow portion. A housing is secured to the forearm portion. An opening is formed that leads into the housing. The opening is disposed near the elbow portion. A spike is disposed within the housing. The spike includes a first end having a point and a second end having a stop. The stop prevents the spike from fully exiting the housing. The present invention further includes a spring biasing the spike to be substantially outside of the housing through the opening. The apparatus includes a deployed position including the spike substantially outside of the housing, and a retracted position including the spike substantially within the housing.

### BACKGROUND OF THE INVENTION

The present invention relates to self-defense and, more particularly, to an arm sleeve with a retractable elbow spike.

Self-defense is a countermeasure that involves defending the well-being of oneself or of another from harm. The use of the right of self-defense as a legal justification for the use of force in times of danger is available in many jurisdictions. Currently, people subject to an attack from behind, such as choke hold or garrote, are left defenseless.

As can be seen, there is a need for an apparatus used for self-defense when attached from behind.

### SUMMARY OF THE INVENTION

In one aspect of the present invention, a self-defense apparatus comprises: a sleeve sized to fit over an arm of a user and comprising a forearm portion and an elbow portion; a housing secured to the forearm portion and comprising an opening leading into the housing, wherein the opening is disposed near the elbow portion; a spike disposed within the housing and comprising a first end comprising a point and a second end comprising a stop configured to prevent the spike from fully exiting the housing; and a spring biasing the spike to be substantially outside of the housing, wherein the apparatus comprises a deployed position comprising the spike substantially outside of the housing, and a retracted position comprising the spike substantially within the housing.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use with a spike extended from a housing;

FIG. 2 is a perspective view of an embodiment of the present invention with a spike retracted within a housing;

FIG. 3 is a perspective view of an embodiment of the present invention with a spike extended from a housing;

FIG. 4 is an exploded view of an embodiment of the present invention;

FIG. 5 is a section view of the present invention taken along line 5-5 in FIG. 2;

FIG. 6 is a section view of the present invention taken along line 6-6 in FIG.5;

FIG. 7 is a section view of the present invention taken along line 7-7 in FIG. 6;

FIG. 8 is a detail section view of an embodiment of the present invention illustrating the release of a safety and the pressing of buttons to move tabs out of a notch and into a channel;

FIG. 9 is a section view of the present invention illustrating the travel of a spike with button tabs within a channel as a spring extends; and

FIG. 10 is a section view of the present invention illustrating with a spike extended from the housing and button tabs locking into a notch.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a protruding elbow spike used as a self-defense weapon. The present invention is worn under one's clothing. The present invention includes an elbow guard device that contains a spike that projects outward when activated by depressing buttons, thereby arming the previously vulnerable individual.

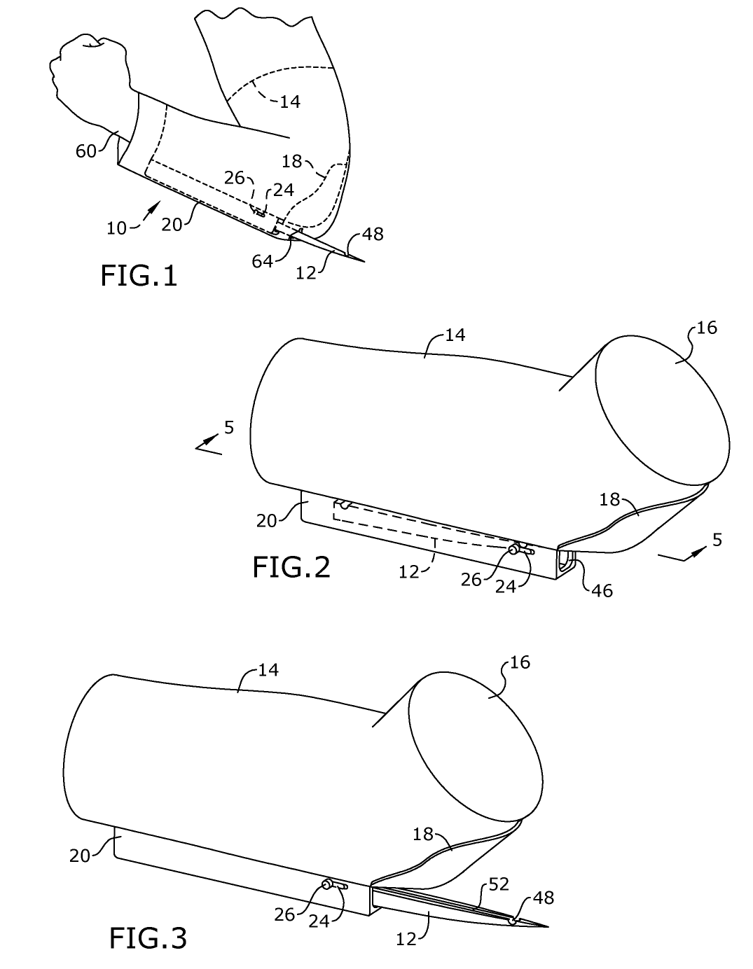

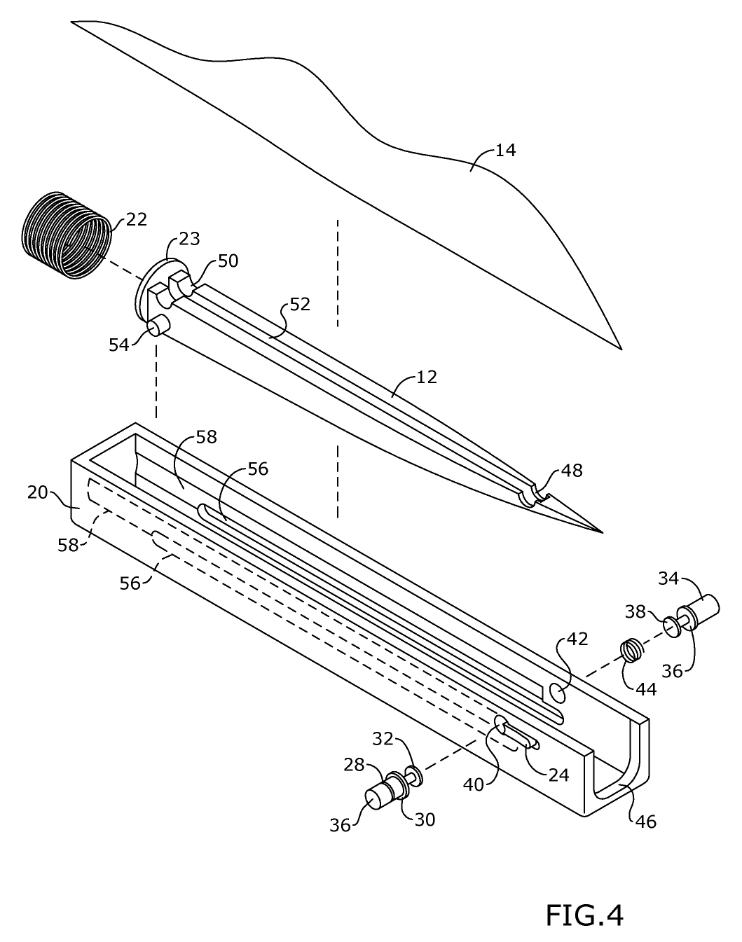

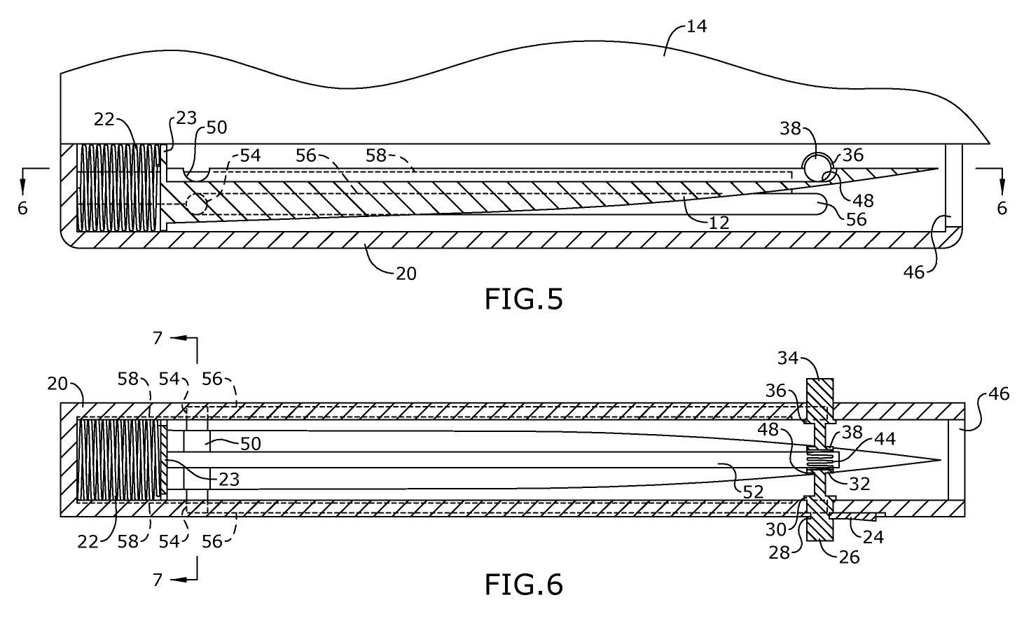

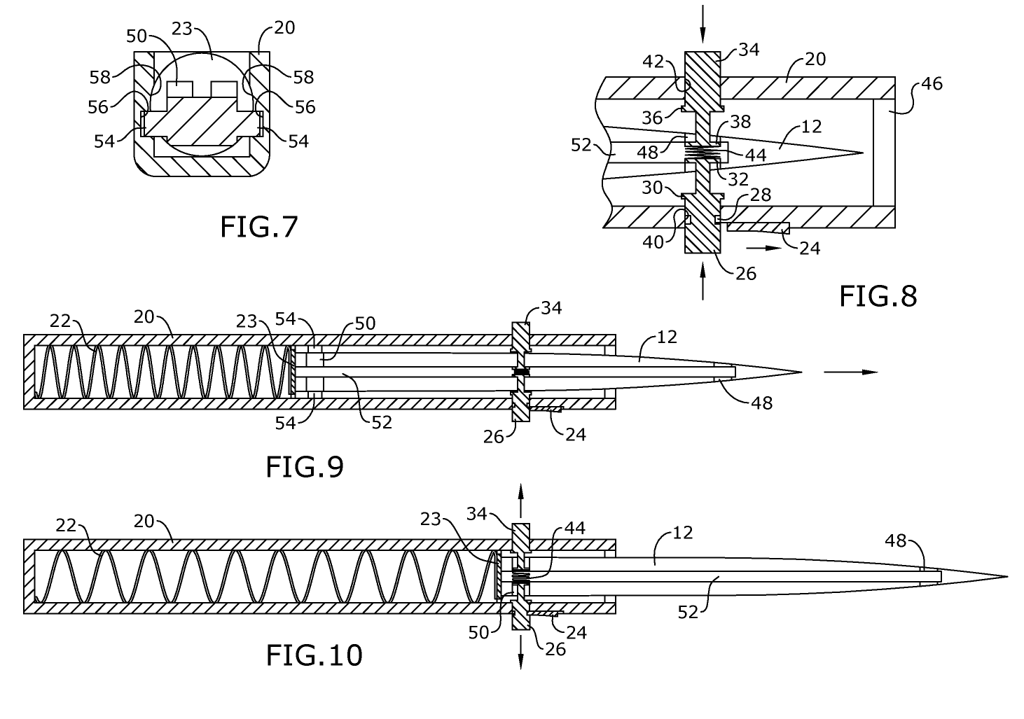

Referring to FIGS. 1 through 10, the present invention includes a self-defense apparatus 10. The apparatus 10 includes a sleeve 14 sized to fit over an arm of a user 60, with a forearm portion, and an elbow portion. A housing 20 is secured to the forearm portion. An opening 46 is formed that leads into the housing 20. The opening 46 is disposed near the elbow portion. A spike 12 is disposed within the housing 20. The spike 12 includes a first end having a point and a second end having a stop 54, 56. The stop 54, 56 prevents the spike 12 from fully exiting the housing 20. The present invention further includes a spring 22 biasing the spike 12 to be substantially outside of the housing 20 through the opening 46. The apparatus 10 includes a deployed position including the spike 12 substantially outside of the housing 20, and a retracted position including the spike 12 substantially within the housing 20.

As mentioned above, the sleeve 14 is sized to secure over a user's arm 60. The sleeve 14 may be made of a stretchable elastic material, such as nylon, and may include a padding 18 secured to the elbow portion. The sleeve 14 includes openings 16 so that a user 60 may place their arm through the sleeve 14. A shirt 64 may be worn over the sleeve 14 in order to conceal the defense apparatus 10. When activated, the spike 12 may puncture the shirt 64, and the user 60 may strike anyone that is grabbing the user from behind.

The present invention further includes a button lock 26, 34. The button lock 26, 34 is operable to lock the spike 12 in the retracted position. In the retracted position, the spring 22 is compressed between an inner end of the housing 20 and a spring plate 23 disposed at the second end of the spike 12. When the user 60 engages the button lock 26, 34, the spike 12 is released and may be pushed by the compressed spring 20 into the deployed position. The spring 22 may fit within and travel along a spring guide groove 58 within the housing 20.

In certain embodiments, the spike 12 may include a first receiving notch 48 running along a width of the spike 12 near the first end and a second receiving notch 50 running along the width near the second end. A channel 52 may be formed along the length of the spike 12 from at least the first receiving notch 48 to the second receiving notch 50. The channel 52 may be substantially perpendicular to the notches 48, 50.

The button lock 26, 34 may include a first button 26 and a second button 34 each protruding through an aperture 40, 42 formed on opposing sides of the housing 20. Each of the first button 26 and the second button 34 includes a button end protruding through the apertures 40, 42, a flange 30, 36 disposed within the housing and protruding beyond an edge of the aperture 40, 42, and a tab 32, 38 extending from an end opposite the button end. The tabs 32, 38 are sized to fit within the first and second receiving notches 48, 50 as well as the channel 52. A spring 44 is disposed in between the tab 32 of the first button 26 and the tab 38 of the second button 36. The spring 44 biases the tabs 32, 38 to be disposed within one of the first and second receiving notches 48, 50 outside of the channel 52, and biasing the flanges 30, 36 against an inner wall of the housing 20.

The button lock 26, 34 may include a safety mechanism. The safety mechanism may include safety latch 24 slidable within a channel formed on an outer surface of the housing 20. The safety latch 24 may be biased within a safety groove 28 formed on one of the button ends of the first button 26 and the second button 34. Therefore, in order to engage the button lock 26, 34 a user slides the safety latch 24 out of the safety groove 28. Requiring an additional step prevents accidental deployment of the spike 12.

The stop 54, 56 of the present invention prevents the spike 12 from flying out of the housing 20 when deployed. The stop 54, 56 may include a pair of tabs 54 extending from either side of the spike 12 at the second end. The tabs 54 may be slidably engaged with a pair of grooves 56 formed on opposing inner surfaces of the housing 20. The grooves 56 may end near the opening 46 of the housing, preventing the second end of the spike 12 from sliding out of the opening 46.

In use, the spike 12 may be first disposed in the retracted position. The retracted position may include the tabs 32, 38 disposed within the receiving notch 48 at the front end of the spike 12. This locks the spike 12 in the retracted position. The user 60 may then slip the sleeve 14 over their arm and wear their clothes. If the user is attached from behind, the user may then press on the first button 34 and the second button 26. The spring 44 in between the tabs 32, 38 is compressed so that the tabs 32, 38 are disposed within the channel 52. When the tabs 32, 38 are disposed within the channel 52, the spike 12 is urged to the extended position by the spring 22. The tabs 54 slide within the grooves 56 and are stopped by terminating ends of the grooves 56. The tabs 32, 38 are urged by the spring 44 into the second receiving notches 50, locking the spike 12 into place. The user may then use the spike 12 for self-defense.

It should be understood, of course, that the foregoing relates to exemplary embodiments of the invention and that modifications may be made without departing from the spirit and scope of the invention as set forth in the following claims.

What is claimed is:

1. A self-defense apparatus comprising:
a sleeve sized to fit over an arm of a user and comprising a forearm portion and an elbow portion;
a housing secured to the forearm portion and comprising an opening leading into the housing, wherein the opening is disposed near the elbow portion;
a spike disposed within the housing and comprising a first end comprising a point and a second end comprising a stop configured to prevent the spike from fully exiting the housing; and
a spring biasing the spike to be substantially outside of the housing, wherein
the apparatus comprises a deployed position comprising the spike substantially outside of the housing, and a retracted position comprising the spike substantially within the housing.

2. The self-defense apparatus of claim 1, further comprising a button lock operable to lock the spike in the retracted position, wherein engaging the button lock releases the spike to the deployed position.

3. The self-defense apparatus of claim 2, wherein the spike comprises a first receiving notch running along a width of the spike near the first end, a second receiving notch running along the width of the spike near the second end, and a channel formed along the length of the spike running from the first receiving notch to the second receiving notch.

4. The self-defense apparatus of claim 3, wherein the button lock comprises a first button and a second button each protruding through an aperture formed on opposing sides of the housing.

5. The self-defense apparatus of claim 4, wherein the first button and the second button each comprises: a button end protruding through the aperture; a flange within the housing and protruding beyond an edge of the aperture; and a tab extending from an end opposite the button end sized to fit within the first and second receiving notches, and the channel.

6. The self-defense apparatus of claim 5, further comprising a spring disposed in between the tab of the first button and the second button, wherein the spring biases the tabs to be disposed within one of the first and second receiving notches outside of the channel, and biasing the flanges against an inner wall of the housing.

7. The self-defense apparatus of claim 5, wherein the button lock further comprises a safety latch disposed within a safety groove formed on one of the button ends of the first button and the second button.

8. The self-defense apparatus of claim 1, wherein the stop comprises at least one tab protruding from the spike near the second end slidably engaged with at least one groove formed on an inner surface of the housing.

9. The self-defense apparatus of claim 1, further comprising an elbow pad secured to the elbow portion.

10. The self-defense apparatus of claim 1, wherein the housing is secured to an underside of the sleeve.

11. The self-defense apparatus of claim 1, further comprising a spring plate attached to the second end of the plate, wherein the spring is disposed in between an inner end of the housing and the spring plate.
